(19) United States
(12) Patent Application Publication
(10) Pub. No.: US 2022/0042629 A1
(43) Pub. Date: Feb. 10, 2022

(54) CLAMPING APPARATUS AND METHOD OF USE THEREOF

(71) Applicant: Teconnex Ltd, Keighley (GB)

(72) Inventor: Arun Kashyap, Keighley (GB)

(73) Assignee: Teconnex Ltd, Keighley (GB)

(21) Appl. No.: 17/280,772

(22) PCT Filed: Sep. 23, 2019
(86) PCT No.: PCT/GB2019/052657

§ 371 Date: Mar. 26, 2021

(30) Foreign Application Priority Data
Sep. 28, 2018 (GB) 1815874.1

(51) Int. Cl. F16L 23/00; F16L 23/08; F16B 7/04; F16B 7/22

(52) U.S. Cl. CPC F16L 23/003; F16B 7/22; F16B 7/0406; F16L 23/08

(57) ABSTRACT

Clamping apparatus is provided for clamping together two or more items in use. The clamping apparatus includes at least one clamp member that can be moved between clamped and undamped positions in use, and joining means for joining together the at least one clamp member and the two or more items in user. The joining means have first engagement means for engagement of the joining means to the at least one clamp member and at least second engagement means for allowing engagement between the joining means and at least one of the items being clamped in user. The joining means has a first edge or side, and a second edge or side different to and a spaced distance apart from the first edge or side. The first engagement means are provided on or associated with the first edge or side and the at least second engagement means are provided on or associated with the second edge or side.

This invention relates to clamping apparatus and to a method of using the clamping apparatus.

Although the following description refers almost exclusively to clamping apparatus for clamping together the ends of an exhaust pipe and a turbo charger, it will be appreciated by persons skilled in the art that the clamping apparatus of the present apparatus can be used to clamp any two items or conduits together in a sealed or unsealed manner for use in any suitable application.

Clamping apparatus of a type comprising a substantially annular clamping band, with a clamping screw located between the two opposing ends of the clamping band that can be moved between clamped and unclamped positions is known. Such apparatus is typically used with a separate annular gasket or washer member to provide a desired seal between the clamping band and the two ends of the conduits being joined together in use. A disadvantage of this apparatus is that the gasket or washer member has to be fitted prior to fitting the clamping band, and therefore requires a multi-stage fitting process which is time consuming and needs two fitters to hold the pipes and clamping apparatus in position. In addition, once the clamping apparatus has been fitted, it is not possible to determine if the gasket or washer member has also been fitted. Sometimes a fitter will forget to fit the gasket or washer member, thereby preventing an adequate seal being formed between the items being clamped.

In an attempt to overcome some of the abovementioned problems, it is known to provide clamping apparatus where a gasket or washer member is pre-fitted to the clamping band, thereby removing the requirement for the washer to be fitted separately on the conduits to the clamping band. It also allows the clamping apparatus to be fitted via a single fitter. One such example of clamping apparatus with integrated gasket is disclosed in US2017/0254454. The apparatus includes a band having a first flank and a second flank, between which an inside trough is formed. The first flank is arranged to fit to a bubble end of a conduit and the second flank is arranged to fit to a flared end of a conduit in use, with the free ends of the conduits located in the trough of the collar when in a clamped position. A washer is retained relative to the band by cooperating with the second flank of the band. The washer is provided with fastening tabs of different types on a first edge of the washer; inside tabs that bear against the inside surface of the second flank when the clamp is in a non-tightened state, outside tabs of a first type that are longer that the inside tabs and cooperate with the inside edge of the second flank, and outside tabs of a second type that cooperate with the outside edge of the second flank via hook shaped free ends. The middle portions of the outside tabs of the second type have tongues that engage with the clamping surface of the flared conduit end.

Problems associated with the above clamp apparatus is that the tabs engage over an external surface and edge of the band flanks, thereby preventing direct contact between the band flange and the surface of the conduit being engaged and providing uneven surface contact between the band flange and the surface of the conduit being engaged. This can result in an even load from the clamp being transferred into an intermittent load on to the conduits by the tabs, which results in uneven deformation of the conduit on the clamping surface. It can also prevent an effective seal being formed between the clamp and the conduits in use.

It is therefore an aim of the present invention to provide clamping apparatus that overcomes the abovementioned problems.

It is a further aim of the present invention to provide a method of using clamping apparatus that overcomes the abovementioned problems.

According to a first aspect of the present invention there is provided clamping apparatus for clamping together two or more items in use, said clamping apparatus including at least one clamp member that can be moved between clamped and unclamped positions in use, and joining means for joining together the at least one clamp member and the two or more items in use, said joining means having first engagement means for engagement of the joining means to the at least one clamp member, and at least second engagement means for allowing engagement between the joining means and at least one of the items being clamped in use, characterised in that the joining means has a first edge or side, and a second edge or side different to and a spaced distance apart from the first edge or side, the first engagement means provided on or associated with the first edge or side and the at least second engagement means provided on or associated with the second edge or side.

Thus, in accordance with the present invention, the means for allowing engagement of the joining means to the at least one clamp member are on a different edge or side of the joining means to the means for allowing engagement of the joining means to at least one of the items in use. This is in contrast to the prior art wherein the different engagement means for the washer are all provided on the same edge of the washer. An advantage of having the first engagement means on a different edge to the second engagement means is that this allows the first engagement means to be seen from the exterior of the clamping apparatus when in a clamped position, thereby allowing for a user to determine whether joining means have been correctly fitted with the clamping apparatus. This is particularly advantageous when the joining means is used to provide a desired seal between the clamping apparatus and the items being clamped.

The integration of the joining means with the clamping member ensures that a user cannot forget to provide joining means with the clamping apparatus. In addition, it ensures the joining means do not engage with an external surface or edge of the at least one clamp member. Thus, the joining means do not form an obstruction between the clamping member and the item, thereby allowing maximum, even contact between the clamping member and the item(s) being clamped in use. This prevents local deformation of the item(s) via the clamp apparatus and, in an embodiment where the joining means is used to form a seal, it prevents or reduces the likelihood of fluid leakage through the seal in use.

A further improved feature of the present invention is that the clamping apparatus can be first fitted to either one of the items to be clamped, such as for example to a flared end conduit or exhaust pipe, or to a bubble end conduit or turbo charger, without the need for any secondary holding devices to be used. Rotational force can be applied to the clamping apparatus when located with at least one item, and torque can be applied to the clamping apparatus when located with two or more items, without securing or supporting any part of the clamping apparatus or item in use (i.e. the apparatus is self-supporting when fitted to one or more items or conduits in use). The clamping apparatus of the present invention can also be fitted by a single fitter, making installation of the apparatus quick and easy.

Preferably the clamping apparatus is arranged so as to form or be moved to and/or between an unclamped and unassembled position; an unclamped and fully assembled or an unclamped and partially assembled position; and a clamped and assembled position.

Preferably the unclamped and unassembled position; the unclamped and assembled or the unclamped and partially assembled position; and the clamped and assembled position are with respect to items to be joined together in use.

Preferably with the clamping apparatus in the unclamped and unassembled position, the at least one clamping member is in a relatively open position and the diameter or width of the opening defined between the at least one clamping member through which at least one of the items is located in use is relatively large. In this position the joining means and/or the at least one clamping member can be inserted over and/or removed from the one or more items being clamped together in use.

Preferably with the clamping apparatus in the unclamped and assembled or partially assembled position, the joining means and the at least one clamp member are located around or engaged to or around at least one of the items. The clamping member is in the relatively open position and the diameter or width of the opening is relatively large. In this position, the clamping apparatus is able to remain engaged with the item(s) without the use of secondary holding devices, thereby freeing a fitter's hands for moving another item into engagement with the item and/or moving the apparatus to a clamped position.

Preferably in a partially assembled position typically the clamping member is only joined to one of the items. In a fully assembled position typically the at least one clamp member is joined to both or all of the items. Reference to “assembled position” in this document can refer to both partially or fully assembled positions unless specifically stated.

Preferably with the clamping apparatus in the clamped and assembled position, the joining means and/or the at least one clamping member engages with at least one of the items, and preferably the at least two items, being clamped together in use. In the clamped positon the at least one clamping member is in a relatively closed position and the diameter or width of the opening defined between the at least one clamping member through which at least one of the items is located in use is relatively small.

Preferably the joining means is located inwardly of the at least one clamp member. For example, the at least one clamp member forms an outer member and the joining means forms an inner member of the clamping apparatus.

Preferably the joining means is in the form of at least one band member, an inner band member, and further preferably at least one annular or substantially annular band member.

Preferably the band member is a continuous or substantially continuous band member.

Preferably the joining means or band member is in the form of a sealing member, a gasket, a collar, a washer and/or the like.

In one embodiment the joining means can be used to provide a seal, desired seal or partial seal between one or more or all of the items being joined and the clamp member when in the clamped and assembled position.

Preferably the joining means is formed from a metal, such as for example stainless steel.

Preferably the first edge of the joining means is arranged to be closer and/or in abutting relationship with the at least one clamp member, and preferably an internal or inwardly facing surface of the at least one clamp member, compared to the second edge of the joining means.

Preferably a diameter or width defined between the first edges (i.e. between opposite portions of the first edges) of the joining means is larger than a diameter or width defined between the second edges of the joining means (i.e. between opposite portions of the second edges). Thus, the first edge can be referred to as an outer edge and the second edge can be referred to as an inner edge.

In one embodiment the wall or walls of the joining means between the first edge and second edge are angled with respect to a horizontal or vertical axis so as to provide the joining means with a narrowing taper from the first edge to the second edge.

In one embodiment the wall or walls of the joining means between the first edge and second edge are complementary or substantially complementary in shape to at least part of a surface of the item or items with which it engages in use.

Preferably the wall or walls of the joining means between the first and second edges provides a joining region supporting the inner edge with respect to the outer edge in use.

In one embodiment the wall or walls of the joining means between the first and second edges provides a sealing region to allow the joining means to provide a sealing function in use (i.e. the region of the joining means that forms a seal or partial seal with the one or more items being clamped together in use).

In one example the wall or walls of the joining means providing a sealing region includes one or more perimeter, circumferential and/or annular beads or protrusions to help form a seal, desired seal or seals. The beads or protrusions can have any required profile suitable for providing a seal or desired seal between the same and the item or items being engaged in use.

Preferably the first engagement means can include a first set of engagement members, a mechanism or member.

Preferably the second engagement means can include a second set of engagement members, a mechanism or member.

In one embodiment the first engagement means for engaging the joining means to the at least one clamp member consists solely of a single first engagement member.

In an alternative embodiment the first engagement means includes a set of first engagement members, mechanism or at least two first engagement members, and preferably each first engagement member is provided separate to and a spaced distance apart on the clamping apparatus. In one example, one of the first engagement members is provided directly opposite to another first engagement member on the joining means.

Preferably the first engagement means is/are arranged to fixedly join the joining means to the at least one clamp member. Preferably this fixation takes place during manufacture of the clamping apparatus. Thus, the joining means can be considered to be integrated with the at least one clamp member.

In one embodiment the at least one clamp member has a hinged section, mechanism or means provided on or associated with the same to help the at least one clamp member to move between the clamped and unclamped positions in use. Preferably the hinged section, mechanism or means is provided opposite adjustment means of the at least clamp member for allowing the at least one clamp member to be moved between clamped and unclamped positions in use.

In one embodiment the at least one clamp member can comprise two or more clamp members with a hinge means and/or resilient biasing means provided between at least two of the clamp members.

Preferably the first engagement means or a first engagement member is provided on or associated with the hinged section or hinge means.

In one embodiment resilient biasing means or mechanism are provided on or associated with the at least one clamp member to help move the at least one clamp member from an unclamped position to a clamped position in use.

Preferably the resilient biasing means or mechanism includes a spring, sprung member and/or the like.

In one example the at least one clamp member includes at least two clamp members with resilient biasing means associated between the clamp members which biases the members towards a clamped position in use.

Preferably a separation means or mechanism can be provided with the apparatus to maintain the clamp members in the unclamped position until the apparatus is ready to be moved to the clamped position.

Preferably one or more link members are provided between the at least two clamp members and the resilient biasing means are provided on or associated with the one or more link members or clamp members.

In one example, the resilient biasing means forms the hinged section of the clamp member.

In one embodiment the at least one clamp member has adjustment means or mechanism associated with free ends or opposing free ends of the at least one clamp member for allowing the at least one clamp member to be moved between the clamped and unclamped positions in use. For example, the adjustment means or mechanism could include one or more nuts and bolts, clips, threaded bolts, trunnion arrangements and/or the like.

Preferably the first engagement means or a first engagement member is provided on or associated with the adjustment means.

Preferably the first engagement means or member could include any or any combination of one or more hooks, clips, tabs, inter-engaging members, pins, screws, nut and bolt, welding, adhesive, and/or the like.

For example, the first engagement means or member is or could include a hook that is hooked or located over the adjustment means or a bolt forming part of the adjustment means in use.

In one example, the first engagement means includes a hook that is located over the adjustment means and a separate hook that is located over the hinge means of the clamping apparatus.

Further preferably opposing surfaces of the hook engaging with the adjustment means in use are resiliently biased inwardly of each other to create an engaging force with the adjustment means or a part of the clamping apparatus with which they engage in use.

Preferably the dimensions of the hook are such that the adjustment means or bolt of the adjustment means are movable within the hook as the adjustment means are moved between the clamped and unclamped positions in use.

Preferably at least the hook has one or more rib members to provide strength to the same in use. Further preferably the one or more rib members are provided longitudinally of the hook (i.e. from the joining means to the free end of the hook).

Preferably the first engagement means or first engagement member is arranged on the adjustment means or at least one clamp member so as to be visible to a user viewing the exterior of the clamping apparatus in use when the clamping apparatus is in a clamped position on the two items in use, thereby allowing the user to visually identify that joining means have been used with the clamping apparatus. This is not currently possible to do with conventional clamping apparatus as any seal is normally hidden within the clamping apparatus and so a user cannot visually determine from the exterior of the fitted clamping apparatus whether the apparatus has been fitted correctly or not.

Preferably the first engagement means or first engagement member(s) is integrally formed with the joining means. Alternatively, or in addition, the first engagement means or first engagement member(s) can be attached to the joining means via suitable attachment means, such as for example via frictional fit, welding, adhesive and/or the like.

In one embodiment the clamp member has first engagement members associated with both the adjustment means and the hinged section or hinged means or resiliently biased section.

Preferably the second engagement means is any means or mechanism arranged so as to provide a desired amount of anti-rotational force and axial resistance when the clamping apparatus is in the unclamped and assembled position and in the clamped and assembled position in use.

Preferably the second engagement means is any means or mechanism arranged so as to allow engagement of the joining means to the one or more items via a frictional fit in use.

In one embodiment the second engagement means include at least one tab member that protrudes outwardly from the second edge of the joining means.

Preferably the at least one tab member is arranged to protrude parallel or substantially parallel to a longitudinal axis of one or more of the items being clamped together in use.

Preferably the second engagement means includes at least two tab members.

In one embodiment at least one of the at least two tab members is for engaging, directly or indirectly, with a surface of one of the items being clamped in use, and at least one other of the at least two tab members is for engaging, directly or indirectly, with a surface of one other of the items being clamped in use.

Preferably a tab member for engagement with one of the items being clamped is located directly adjacent to a tab member for engagement with the other one of the items being clamped in use.

Preferably six tab members are provided; three of the tab members are for engaging with a surface of one of the items being clamped in use, and three other of the tab members are for engaging with a surface of one of the other items being clamped in use.

It will be appreciated that more or less tab members could be provided based on, for example, the dimensions of the joining means.

In one embodiment all the tab members of the second engagement means are for engaging, directly or indirectly, with a surface of one of the items being clamped in use.

In one embodiment the second engagement means consists of or includes one or more barb members. Preferably the one or more barb members are for engaging directly with a surface of the one or more items being clamped in use.

In one embodiment the one or more barb members protrude outwardly directly from the second edge of the joining means (i.e. the barb members are not provided on tab members).

Preferably the one or more barb members are arranged such that they allow movement of the barb member relative to a surface of the one or more items in a first direction, but prevent, substantially prevent or make it difficult for movement of the barb member relative to the surface of the one or more items in a second or opposite direction to the first direction. For example, the one or more barb members are arranged so as to allow the barb members to move in a direction into an interior of an item or conduit but prevent, or substantially prevent, the barb member from being withdrawn from the interior of the item or conduit in use.

Preferably the one or more tab members are arranged such that they allow alignment of the joining means with the one or more items in use and/or allow movement of the tab member relative to a surface of the one or more items in a first direction and in a second or opposite direction to the first direction.

In one embodiment at least one barb member is defined on a, or each, tab member.

Preferably a barb member for engaging with one of the items in use is arranged to protrude outwardly from a tab member and/or joining means in an opposite direction to a barb member for engaging with one of the other items in use.

Preferably a barb member is arranged to protrude outwardly or inwardly from a surface of the tab member and/or joining means at an acute angle thereto.

In one embodiment all the barb members protrude from the joining means in the same direction (i.e. all outwardly protruding or all inwardly protruding).

In one embodiment at least one barb member protrudes outwardly of the joining means, and at least one barb member protrudes inwardly of the joining means or in a direction opposite or away from the outwardly protruding barb means.

Preferably a free leading edge of the barb member defines an engaging edge for engaging with a surface, and preferably an interior or exterior surface, of the item being clamped in use.

Preferably the second engagement means can be attached to the joining means and/or integrally formed with the joining means.

Preferably the one or more tab members and/or barb members are resiliently biased inwardly and/or outwardly of the joining means to allow flexion or a degree of flexion of the same during the assembly process of the clamping apparatus with the items in use.

Preferably the one or more tab members and/or barb members are arranged so as to be rigid or relatively rigid once the clamping apparatus is assembled on the items in a clamped position in use.

Preferably the two or more items being clamped together in use are any or any combination of pipes, conduits, hosing, channel members, sleeve members, flared end conduit, bubble end conduit, exhaust pipe, turbo charger and/or the like.

Preferably one of the items being clamped is a female conduit, a conduit having an outwardly flared end and/or an exhaust pipe.

Preferably one of the other items being clamped is a male conduit or a conduit having a bubble end, or an end with a portion of greater diameter arranged a spaced distance from the free end. The male conduit or bubble end conduit can also be an outlet to a turbo charger.

In one embodiment the at least one clamping member is in the form of an outer clamping band member.

Preferably the at least one clamping member is annular or substantially annular in form.

Preferably the at least one clamping member has two opposing free ends.

Preferably the adjustment means for allowing the at least one clamping member to be moved between the clamped and unclamped positions are provided on or associated with or between the two opposing free ends.

Preferably each opposing free end of the at least one clamping member is provided with connection portions protruding outwardly of the clamping member.

Preferably the adjustment means are provided on or associated with the connection portions of the at least one clamping member.

Preferably each, or at least one of the connection portions, has an aperture defined through the same and the adjustment means are located through each aperture or the aperture in use.

In one embodiment the at least one clamping member has a profiled inner or inwardly facing surface.

Preferably the profiled inner or inwardly facing surface of the at least one clamping member defines an inwardly facing trough or channel therein. Preferably a flared end conduit and a bubble end conduit are arranged to be located in the trough or channel when in a clamped position in use.

Preferably the profiled inner or inwardly facing surface is V-shaped, substantially V-shaped, U-shaped or substantially U-shaped.

Preferably the profiled inner or inwardly facing surface of the at least one clamping member has two opposing side walls defining the channel or trough therebetween. In one embodiment a base wall is provided between the two opposing side walls.

In one embodiment the at least one clamping member is in the form of a V-clamp or G-clamp.

Preferably the joining means is located within (or forms an inner band with) the at least one outer clamping member and is arranged in overlapping relationship with the same in the clamped and/or unclamped positions (such as for example in a cross-sectional view of the apparatus).

According to a second aspect of the present invention there is provided a method of using clamping apparatus for clamping together two or more items in use, said clamping apparatus including at least one clamp member, and joining means for joining together the at least one clamp member and the two or more items in use, the joining means having first engagement means for engagement of the joining means to the at least one clamp member, and at least second engagement means for allowing engagement between the joining means and at least one of the items being clamped in use, said method including the steps of locating the joining means and the at least one clamp member around at least one of the items to be clamped; engaging one or more of the second engagement means of the joining means with at least one of the items to be clamped, and moving the at least one clamp member from an unclamped position to a clamped position, characterised in that the joining means has a first edge or side, and a second edge or side different to and a spaced distance apart from the first edge or side, the first engagement means provided on or associated with the first edge or side and the at least second engagement means provided on or associated with the second edge or side.

Preferably after one or more of the second engagement means has engaged with a first of the items to be clamped, a second item to be clamped is moved into engagement with the first item, joining means and/or at least one clamp member.

Preferably one or more further of the second engagement means are engaged with the second item to be clamped.

Preferably the second engagement means include barb members and the barb members engaging with the first item protrude in an different or opposite direction to the barb members engaging with the second item.

Preferably the second engagement means includes one or more tab members and the tab members are located in an interior of the one or more items being joined together in use.

According to further aspects of the present invention there is provided clamping apparatus for clamping together a female conduit or flared end conduit and a male conduit or a bubble end conduit; and/or a method of using the clamping apparatus.

According to one aspect of the present invention there is provided clamping apparatus for clamping together at least first and second items in use, said clamping apparatus including at least one clamp member that can be moved between clamped and unclamped positions in use, and joining means for allowing the at least one clamp member and the at least first and second items to be joined together in use, said joining means having first engagement means for allowing engagement of the joining means to the at least one clamp member in use, and at least second engagement means for allowing engagement between the joining means and at least one of the first and second items being clamped in use, characterised in that second engagement means includes a first set of second engagement means capable of engagement with the at least first item in use, and a second set of second engagement means capable of engagement with the at least second item in use.

Preferably the first and second set of second engagement means protrude outwardly from, are provided on and/or associated with the same edge or end of the joining means.

Preferably the joining means has a first edge, and a second edge different to and a spaced distance apart from the first edge. The first engagement means is provided on or associated with the first edge and the at least second engagement means provided on or associated with the second edge of the joining means.

In one embodiment orientation means are provided on or associated with the clamping apparatus to ensure the clamping apparatus can only be fitted in one orientation in use, or one or more pre-determined orientations in use. For example, the orientation means can include an alignment feature.

According to one aspect of the present invention there is provided an integrated gasket and clamp apparatus; and/or a method of using an integrated gasket and clamp apparatus.

Embodiments of the present invention will now be described with reference to the following figures, wherein:

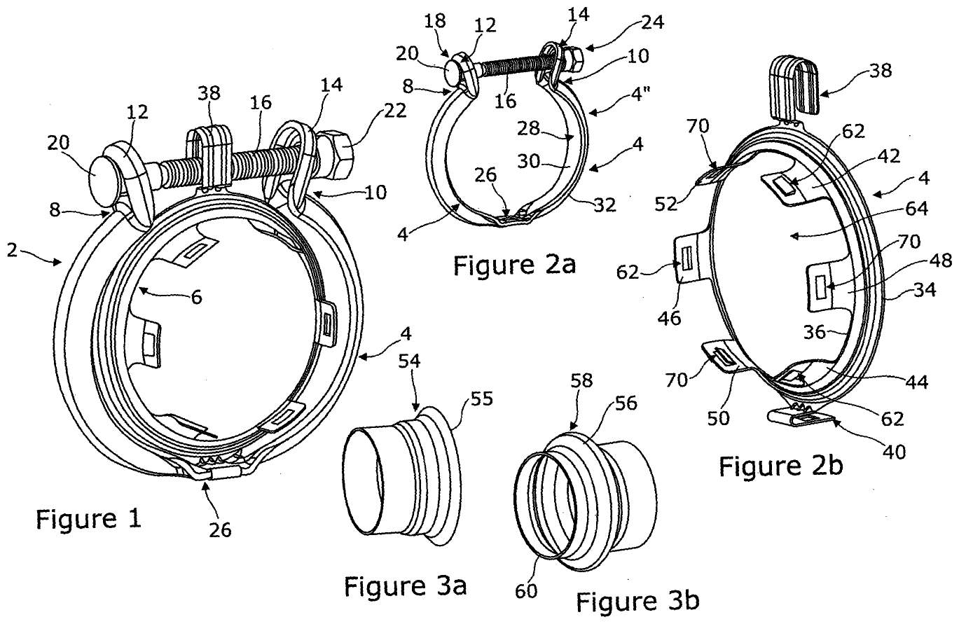

FIG. 1 is a perspective view of clamping apparatus according to an embodiment of the present invention;

FIGS. 2a and 2b show the clamping member only in FIG. 1, and the joining means or gasket member only in FIG. 1 respectively;

FIGS. 3a and 3b show a female or flared end conduit, and a male or bubble end conduit respectively on which the clamping apparatus in FIG. 1 can be used;

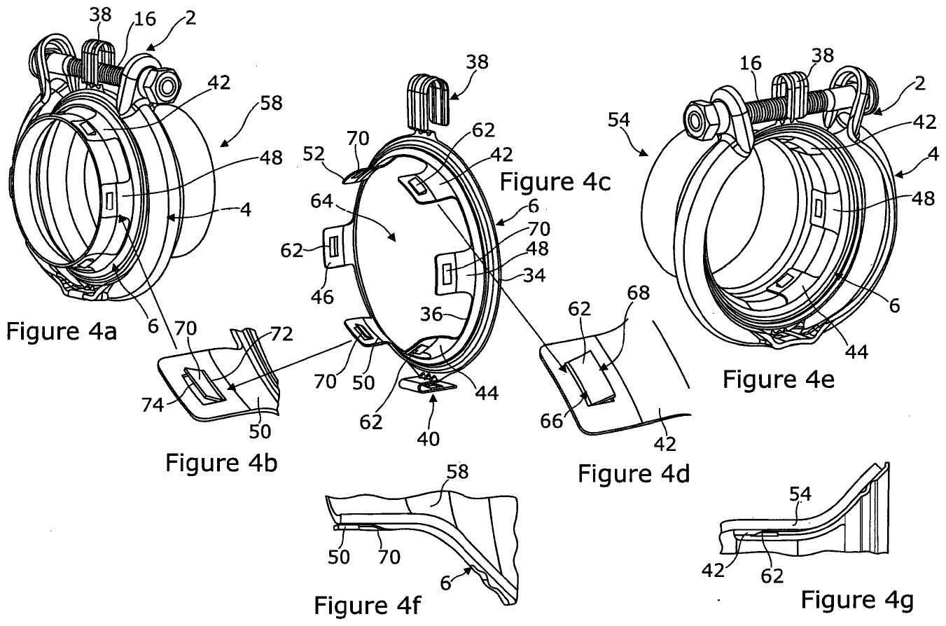

FIG. 4a shows the clamping apparatus of FIG. 1 fitted to a male or bubble end conduit in a partially assembled and unclamped position;

FIG. 4b shows a detailed view of a tab and barb in FIGS. 4a and 4c;

FIG. 4c shows a perspective view of the joining means or gasket only of FIG. 1;

FIG. 4d shows a detailed view of a tab and barb in FIGS. 4c and 4e;

FIG. 4e shows the clamping apparatus of FIG. 1 fitted to a female or flared end in a partially assembled and unclamped position;

FIG. 4f shows a cross sectional view of part of the clamping apparatus fitted to the male or bubble end conduit; and

FIG. 4g shows a cross sectional view of part of the clamping apparatus fitted to the female or flared end conduit;

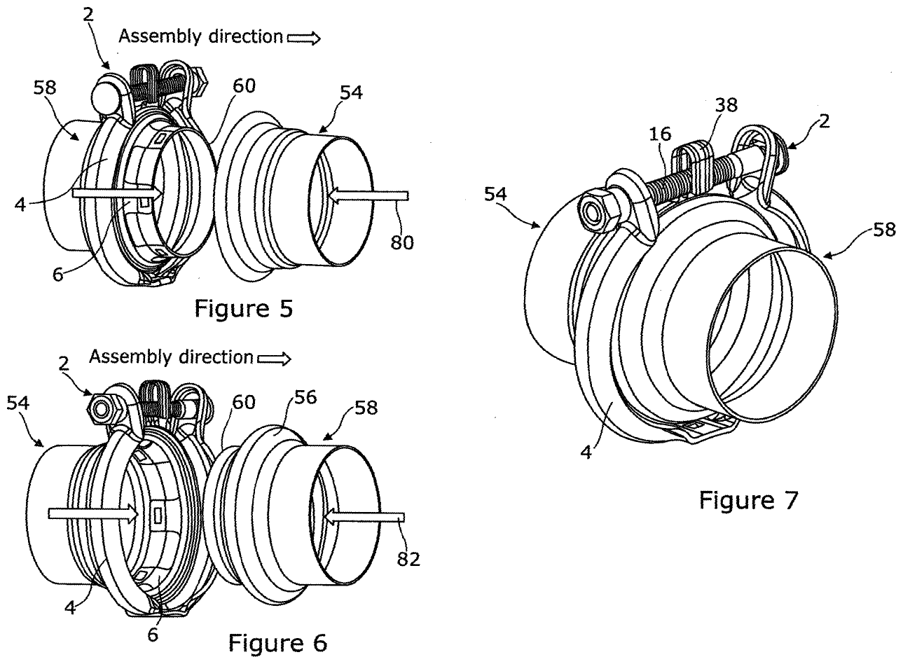

FIG. 5 shows the clamping apparatus of FIG. 1 located on a male or bubble end conduit in an assembled or partially assembled and unclamped position and being fitted to a female or flared end conduit in use;

FIG. 6 shows the clamping apparatus of FIG. 1 located on a female or flared end conduit in an assembled or partially assembled and unclamped position and being fitted to a male or bubble end conduit in use;

FIG. 7 shows the clamping apparatus of FIG. 1 when fitted on a female or flared end conduit and a male or bubble end conduit in a fully assembled and unclamped position;

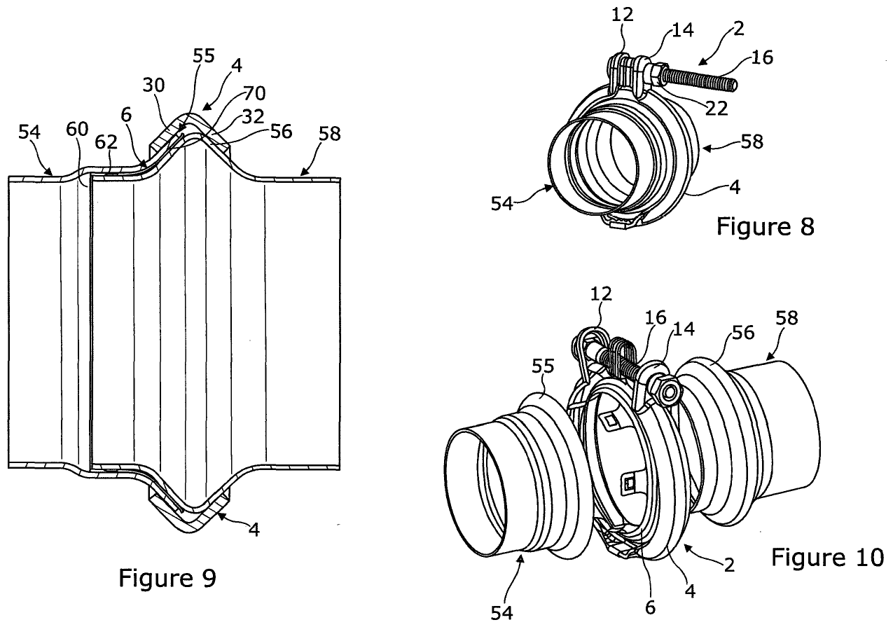

FIG. 8 shows the clamping apparatus of FIG. 7 in a clamped and assembled position;

FIG. 9 shows a cross sectional view taken through the clamping apparatus of FIG. 8;

FIG. 10 shows an exploded view of the clamping apparatus in FIG. 7;

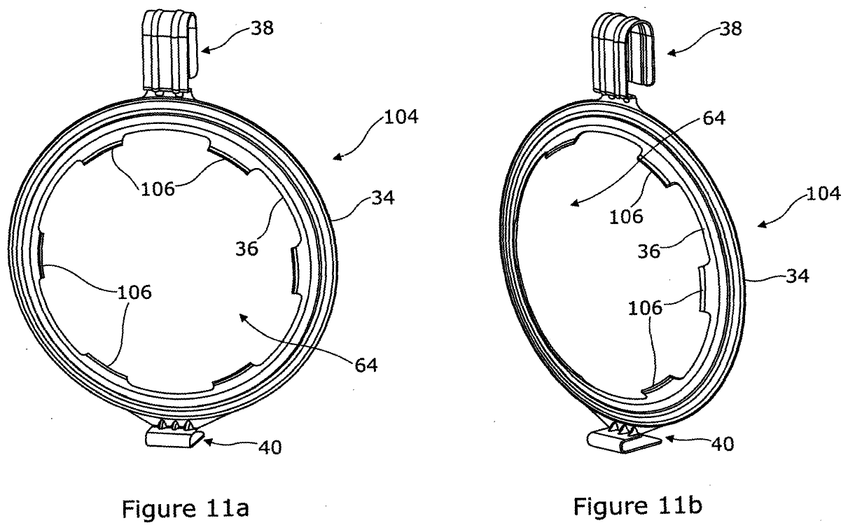

FIGS. 11a and 11b show a front view and a perspective view of joining means or a gasket for use with the clamping apparatus according to an embodiment of the present invention.

Referring firstly to FIGS. 1-2b, there is illustrated clamping apparatus according to an embodiment of the present invention in the form of an integrated gasket clamp 2. The clamp 2 is for clamping together two conduits and for providing a desired seal between the same.

The clamp 2 comprises an outer clamping band member 4 and joining means in the form of an inner gasket member 6. The inner gasket member 6 is fixedly attached to the outer clamping band member 4 and is arranged in overlapping relationship with the same when in clamped and unclamped positions.

The outer clamping band member 4 is almost annular inform with two opposing free ends 8, 10 having connecting portions 12, 14 protruding outwardly from the band member 4. Each connecting portion 12, 14 has an aperture defined through the same for receiving part of adjustment means in use. In the illustrated embodiment the adjustment means is in the form of a threaded bolt 16 that passes through the apertures in the connecting portions 12, 14, having a first end 18 with a stop member 20 to prevent removal of the bolt 16 through aperture 12 in use, and an adjustment nut 22 provided at a second end 24 to allow movement of the connecting portions 12, 14 (and therefore the band member 4) between clamped and unclamped positions.

In the clamped position, the connecting portions 12, 14 are relatively close together and the items being clamped in use are held together between the clamping apparatus 2. In the unclamped position, the connecting portions 12, 14 are relatively further apart from each other compared to the clamped position, and the items to be clamped can be located within and/or removed from the clamping apparatus. The connecting portions 12, 14 allows load to be transferred from the adjustment means to the band member 4 in use. It is to be noted that in the unclamped position, the apparatus can be provided in an unassembled position wherein it is not engaged to the conduits; a partially assembled position, wherein it is engaged to one conduit; or a fully assembled position, wherein it is engaged to both conduits. In the clamped position, the apparatus is typically in the assembled position.

A hinge portion 26 is provided centrally of the outer band member 4 and opposite to the adjustment means. The hinge portion 26 allows the adjacent clamping parts 4′, 4″ of the band member 4 to be moved inwardly towards the conduits being clamped to form the clamped position in use.

The outer band member 4 has a profiled inner surface 28. For example, the outer band member 4 can be of a type often referred to as a V-clamp or a G-clamp. More particularly, the outer band member 4 is profiled so as to form an inwardly facing trough or channel having a base wall and two opposing side walls, or two opposing side walls 30, 32 (depending on the profile of the band member). The opposing side walls 30, 32 protrude radially inwardly of the band member. The opposing side walls 30, 32 typically interact directly with the outer surfaces of the conduits being clamped in use.

The gasket 6 in one example can be formed from stainless steel in order to withstand the high temperatures of the fluid that may pass through the conduits being clamped in use.

The gasket 6 is in the form of a continuous annular band having a first outer edge 34 and a second inner edge 36. The region of the band between the outer and inner edges 34, 36 provides the sealing region of the gasket. The sealing region is arranged so as to be complementary or substantially complementary in shape to the surface(s) of the conduit(s) being clamped/engaged by the sealing gasket in use. The sealing region also includes a number of circumferential protrusions that can protrude inwardly and/or outwardly of the gasket so as to enhance the sealing effect of the sealing region in use.

The first outer edge 34 has a larger diameter than the second inner edge 36, such that the gasket has a narrowing taper from the first outer edge 34 towards the second inner edge 36.

In accordance with the present invention, gasket 6 is provided with first engagement means on the first outer edge 34 for allowing engagement of the gasket 6 to the outer clamping band 4, and second engagement means provided on the second inner edge 36 for allowing engagement of the gasket with one or both of the conduits being clamped by the clamping apparatus 2 in use. More particularly, the first engagement means includes a first hook element 38 for location over the threaded bolt 16 of the adjustment means, and a second hook element 40 for location over the hinge portion 26 of the outer clamping band 4. The second engagement means includes a first set of tab members 42, 44, 46 protruding outwardly of the gasket 6 in a direction away from first outer edge 34, and a second set of tab members 48, 50, 52 also protruding outwardly of the gasket 6 in a direction away from first outer edge 34. The tab members 42-52 are provided parallel or substantially parallel to a longitudinal axis of the conduits being clamped in use. Each tab member 42-52 is provided with a barb member thereon for allowing engagement of the gasket with a surface of a conduit in use, as will be described in more detail below. The barb members frictionally engage with one or more surfaces of the conduits being clamped together and generate axial and rotational resistance to a desired level to ensure the clamp does not disconnect from the conduits in use.

The clamping apparatus 2 in this example is used for clamping together two conduits in the form of a flared end conduit or female conduit 54 and a bubble end conduit or male conduit 58, as shown in FIGS. 3a and 3b respectively. The flared end conduit 54 has an outwardly tapered end 55, and the bubble end conduit 58 has a protruding region 56 of greater diameter compared to the free end 60 of the conduit and is a spaced distance set back from the free end 60.

A barb member 62 is provided on each of the first set of tab members 42, 44, 46 and protrudes outwardly from an outwardly facing surface of the tab members. The barb member 62 is joined to the tab members 42-46 at one end 66 thereof. A free end 68 of barb member 62 opposite to the end 66 faces towards the first outer edge 34 of the gasket 6, as shown in FIG. 4d.

A barb member 70 is provided on each of the second set of tab members 48, 50, 52 and protrudes inwardly from an inwardly facing surface of the tab members. The barb member 70 is joined to each tab member 48-52 at one end 72 thereof. A free end 74 of barb member 70 opposite to the end 74 faces away from first outer edge 34 of gasket 6, as shown in FIG. 4b.

An advantage of the barb members 62, 70 protruding in opposite directions from the tab members is that they allow the clamping apparatus 2 of the present invention to be engaged with either the flared end conduit 54 and/or the bubble end conduit 58, as shown in FIGS. 4e and 4a respectively. This is in contrast to the prior art clamping apparatus wherein the tab members can only be used to clamp to a flared end of a conduit. Thus, the clamping apparatus of the present invention can be pre-mounted of affixed to either of the conduits 54, 58 without the need for a secondary holding device to be used to secure the other conduit in position.

On assembly, the clamping apparatus 2 is first fitted to either the flared end conduit 54 or the bubble end conduit 58 with the apparatus in an unclamped position, as shown in FIGS. 6 and 5 respectively. More particularly, in order to first fit the clamping apparatus 2 to the bubble end conduit 58, the apparatus 2 is located over the free end 60 of conduit 58 to sit over and around the bubble portion 56 of conduit 58, as shown in FIG. 5. The inwardly protruding barb members 70 located on tab members 48, 50, 52 engage with the exterior facing surface of the conduit 58. The flared end 55 of the conduit 54 is then moved into engagement with the end 60 of conduit 58, as shown by arrow 80. The outwardly protruding barb members 62 located on tab members 42, 44, 46 engage with the interior facing surface of the conduit 54. The adjustment nut 22 of the clamping apparatus 2 is then rotated to allow the connection portions 12, 14 of band member 4 to be brought together and move the clamping apparatus 2 to a clamped position.

In order to first fit the clamping apparatus 2 to the flared end conduit 54, the tab members of the gasket 6 of apparatus 2 are located in the interior of conduit 54, as shown in FIG. 6. The outer clamping band member 4 is positioned on the exterior of the conduit 54. The outwardly protruding barb members 62 located on tab members 42, 44, 46 engage with the interior facing surface of the conduit 54. The free end 60 of the conduit 58 is then moved into engagement into the end 55 of conduit 54, as shown by arrow 82. The inwardly protruding barb members 70 located on tab members 48, 50, 52 engage with the exterior facing surface of the conduit 58. The adjustment nut 22 of clamping apparatus 2 is then rotated to allow the connection portions 12, 14 of clamping band member 4 to be brought together and move the clamping apparatus 2 to a clamped position.

Referring to FIGS. 11a and 11b, there is illustrated a further embodiment of a gasket 104 that can be used with the clamping band 4 of the present invention. The same references have been used to refer to the same features as in FIG. 2b of the first described embodiment. In this embodiment a plurality of barb members 106 are provided directly on second inner edge 36 of the gasket 104 in a spaced apart arrangement, and protrude outwardly of the gasket 4 in a direction towards aperture 64. This embodiment can be used if the clamping apparatus is to engage only with the bubble end conduit 58.

Thus, in accordance with the present invention, in one embodiment one set of the second engagement means or barb means protrude inwardly of the apparatus, thereby allowing engagement with the bubble end conduit 58 in addition to or as an alternative to engagement with the flared end conduit. In the prior art, the barb means associated with the tab members only protrude outwardly of the apparatus and can only be engaged with the flared end conduit. Assembly of the clamp apparatus to the bubble end conduit allows for a more robust assembly process as the bubble end conduit is typically more easy to manipulate and handle. In the present invention, the clamping apparatus is arranged such that there is direct engagement between the outer clamping band and the exterior surface of the flared end conduit and the bubble end conduit, thereby providing increased axial loading and an increased even load transfer from the clamp face to the flanged end conduit face.

1: Clamping apparatus for clamping together two or more items in use, said clamping apparatus including at least one clamp member that can be moved between clamped and unclamped positions in use, and joining means for joining together the at least one clamp member and the two or more items in use, said joining means having first engagement means for engagement of the joining means to the at least one clamp member, and at least second engagement means for allowing engagement between the joining means and at least one of the two or more items being clamped in use, characterised in that the joining means has a first edge or side, and a second edge or side different to and a spaced distance apart from the first edge or side, the first engagement means provided on or associated with the first edge or side and the at least second engagement means provided on or associated with the second edge or side.

2. (canceled)

3: Clamping apparatus according to claim 1 wherein the joining means is in the form of at least one of a band member; an inner band member; an annular or substantially annular band member; a continuous or substantially continuous band member; a sealing member; a gasket; collar; and/or washer.

4: Clamping apparatus according to claim 1 wherein the first edge of the joining means is arranged to be closer and/or in abutting relationship with the at least clamp member compared to the second edge of the joining means.

5: Clamping apparatus according to claim 1 wherein the wall or walls of the joining means between the first and second edges have one or more of the following: the walls are angled so as to provide the joining means with a narrowing taper from the first edge to the second edge; the walls are complementary or substantially complementary in shape to at least part of a surface of at least one of the two or more items with which it is to engage in use; the walls provide a sealing region to allow the joining means to provide a sealing function in use.

6. (canceled)

7: Clamping apparatus according to claim 1 wherein the first engagement means includes a single first engagement member, or at least two separate and spaced apart first engagement members; and wherein the first engagement means is provided on or associated with hinge means or resilient biasing means of the at least one clamp member and/or adjustment means of the at least one clamp member for allowing the at least one clamp member to be moved between the clamped and unclamped positions in use.

8-10. (canceled)

11: Clamping apparatus according to claim 1 wherein the first engagement means include any combination of one or more hooks, clips, tabs, inter-engaging members, pins, screws, nut and bolt, welding or adhesive.

12: Clamping apparatus according to claim 11 wherein the first engagement means is or includes a hook, and opposing surfaces of the hook are resiliently biased inwardly of each other to create an engaging force with the adjustment means or a part of the clamping apparatus with which the opposing surfaces of the hook engage in use; and wherein the first engagement means is or includes a hook, said hook including one or more rib members provided longitudinally of the hook.

13. (canceled)

14: Clamping apparatus according to claim 1 wherein the at least second engagement means includes at least one tab member that protrudes outwardly from the second edge of the joining means.

15. (canceled)

16: Clamping apparatus according to claim 1 wherein the at least second engagement means includes at least two tab members; at least one of the at least two tab members is for engaging, directly or indirectly, with a surface of one of the two or more items being clamped in use, and at least one other of the at least two tab members is for engaging, directly or indirectly, with a surface of one other of the two or more items being clamped in use.

17. (canceled)

18: Clamping apparatus according to claim 1 wherein the at least second engagement means includes or consists of one or more barb members, the one or more barb members arranged so as to allow movement of the barb member relative to a surface of at least one of the two or more items in use in a first direction, but prevent or substantially prevent movement of the barb member relative to a surface of the two or more items in use in a second or opposite direction; wherein the one or more barb members protrude outwardly directly from the second edge of the joining means; and wherein the at least second engagement means includes at least one tab member and one or more barb members are provided on said at least one tab member.

19-21. (canceled)

22: Clamping apparatus according to claim 18 wherein a barb member for engaging with at least one of the two or more items in use is arranged to protrude outwardly from a tab member and/or joining means in an opposite direction to a barb member for engaging with one of the other two or more items in use.

23: Clamping apparatus according to claim 1 wherein the at least second engagement means includes one or more tab members and/or barb members and said members are resiliently biased inwardly and/or outwardly of the joining means during an assembly process of the clamping apparatus with the items in use.

24-25. (canceled)

26: A method of using clamping apparatus for clamping together two or more items in use, said clamping apparatus including at least one clamp member, and joining means for joining together the at least one clamp member and the two or more items in use, the joining means having first engagement means for engagement of the joining means to the at least one clamp member, and at least second engagement means for allowing engagement between the joining means and at least one of the two or more items being clamped in use, said method including the steps of locating the joining means and the at least one clamp member around at least one of the two or more items to be clamped; engaging one or more of the second engagement means of the joining means with at least one of the two or more items to be clamped, and moving the at least one clamp member from an unclamped position to a clamped position, characterised in that the joining means has a first edge or side, and a second edge or side different to and a spaced distance apart from the first edge or side, the first engagement means provided on or associated with the first edge or side and the at least second engagement means provided on or associated with the second edge or side.

27: The method of claim 26 wherein after one or more of the at least second engagement means has engaged with a first of the two or more items to be clamped, a second item to be clamped is moved into engagement with the first item, joining means and/or at least one clamp member.

28: The method of claim 27 wherein one or more further second engagement means are engaged with the second item to be clamped; wherein the at least second engagement means include barb members and the barb members engaging with the first item protrude in an different or opposite direction to the barb members engaging with the second item; and wherein the at least second engagement means includes one or more tab members and the tab members are located in an interior of the one or more of the two or more items being joined together in use.

29-30. (canceled)
